(19) United States
(12) Patent Application Publication
(10) Pub. No.: US 2026/0237563 A1
(43) Pub. Date: Aug. 13, 2026

(54) MULTILAYER CERAMIC ELECTRONIC COMPONENT AND METHOD FOR MANUFACTURING MULTILAYER CERAMIC ELECTRONIC COMPONENT

(71) Applicant: TAIYO YUDEN CO., LTD., Tokyo (JP)

(72) Inventors: Chizuru TADOKORO, Gunma (JP); Satoshi KOBAYASHI, Tokyo (JP); Taiga SAITO, Gunma (JP); Wakaaki MURAI, Tokyo (JP); Seiya SUGAI, Tokyo (JP)

(21) Appl. No.: 19/457,706

(22) Filed: Jan. 23, 2026

(30) Foreign Application Priority Data
Feb. 10, 2025 (JP) 2025-020312

(51) Int. Cl. H01G 4/232; H01G 4/008; H01G 4/012; H01G 4/12; H01G 4/30

(52) U.S. Cl. CPC H01G 4/2325; H01G 4/008; H01G 4/012; H01G 4/12; H01G 4/30

(57) ABSTRACT

A multilayer ceramic electronic component includes an element body in which a plurality of internal electrodes and a plurality of dielectric layers having a ceramic as a main component are alternately laminated, the element body having end surfaces opposite each other in a longitudinal direction in which each of the plurality of internal electrodes extends, a base metal layer provided on each of the end surfaces to be in contact with at least part of the plurality of internal electrodes exposed at either one of the end surfaces, a coating layer covering the base metal layer, and a plating layer covering the coating layer and forming an external electrode together with the base metal layer and the coating layer.

### CROSS-REFERENCE TO RELATED APPLICATION

The present application is based on and claims priority to Japanese patent application No. 2025-020312 filed on February 10, 2025, with the Japan Patent Office, the entire contents of which are hereby incorporated by reference.

### BACKGROUND OF THE INVENTION

### Field of the Invention

The disclosures herein relate to multilayer ceramic electronic components and methods for manufacturing multilayer ceramic electronic components.

### Description of the Related Art

An external electrode in a multilayer ceramic electronic component such as a multilayer ceramic capacitor includes a base metal layer in contact with an element body and a plating layer covering the base metal layer. In the external electrode, it is known that at least one element that forms a supply-bond-type hydride with hydrogen or that forms a hydride in a boundary region with hydrogen is contained between the outermost plating layer and the element body (e.g., Patent Literature (PTL) 1). It is known that there is a region in which Sn is deposited between the base metal layer and a Ni plated layer (e.g., PTL 2).

The plating layer contains a large amount of hydrogen. When hydrogen in the plating layer diffuses into the element body, insulation resistance of a dielectric layer decreases, and reliability of the multilayer ceramic electronic component decreases when a voltage is applied.

The present disclosure aims to provide a multilayer ceramic electronic component that reduces the diffusion of hydrogen into the element, and a method for manufacturing the same.

### CITATION LIST

### Patent Literature

[PTL 1] Japanese Laid-Open Patent No. 2016-058719

[PTL 2] International Publication WO 2024/047980

### SUMMARY OF THE INVENTION

An embodiment of the present disclosure is a multilayer ceramic electronic component including an element body in which a plurality of internal electrodes and a plurality of dielectric layers having a ceramic as a main component are alternately laminated, the element body having end surfaces opposite each other in a longitudinal direction in which each of the plurality of internal electrodes extends, a base metal layer provided on each of the end surfaces to be in contact with at least part of the plurality of internal electrodes exposed at either one of the end surfaces, a coating layer covering the base metal layer, and a plating layer covering the coating layer and forming an external electrode together with the base metal layer and the coating layer.

An embodiment of the present disclosure is a multilayer ceramic electronic component including an element body in which a plurality of internal electrodes and a plurality of dielectric layers having a ceramic as a main component are alternately laminated, the element body having end surfaces opposite each other in a longitudinal direction in which each of the plurality of internal electrodes extends, a base metal layer provided on each of the end surfaces to be in contact with at least part of the plurality of internal electrodes exposed at either one of the end surfaces, and provided with an opening, a coating layer covering the base metal layer, and being a sputtering layer, and a plating layer covering the coating layer and forming an external electrode together with the base metal layer and the coating layer.

An embodiment of the present disclosure is a method of manufacturing a multilayer ceramic electronic component including preparing an element body in which a plurality of internal electrodes and a plurality of dielectric layers having a ceramic as a main component are alternately laminated, the element body having end surfaces opposite each other in a longitudinal direction in which each of the plurality of internal electrodes extends, forming a base metal layer provided on each of the end surfaces to be in contact with at least part of the plurality of internal electrodes exposed at either one of the end surfaces, and provided with an opening, forming a coating layer covering the base metal layer using a sputtering method, and forming a plating layer covering the coating layer and forming an external electrode together with the base metal layer and the coating layer using a plating method.

The present disclosure can provide a multilayer ceramic electronic component that reduces the diffusion of hydrogen into the element, and a method for manufacturing the same.

### BRIEF DESCRIPTION OF THE DRAWINGS

FIG. 1 is a partial cross-sectional perspective view illustrating a multilayer ceramic capacitor 100 according to a first embodiment;

FIG. 2 is a cross-sectional view taken along a line A-A of FIG. 1;

FIG. 3 is a cross-sectional view taken along a line B-B of FIG. 1;

FIG. 4 is a flowchart illustrating a method for manufacturing a multilayer ceramic capacitor according to the first embodiment;

FIG. 5 is a perspective view illustrating the method of manufacturing the multilayer ceramic capacitor according to the first embodiment;

FIG. 6 is a cross-sectional view illustrating a multilayer ceramic capacitor according to a first comparative embodiment;

FIG. 7 is a cross-sectional view illustrating a multilayer ceramic capacitor according to a second comparative embodiment;

FIG. 8 is a cross-sectional view illustrating a multilayer ceramic capacitor according to a first example of the first embodiment;

FIG. 9 is a cross-sectional view illustrating a multilayer ceramic capacitor according to a second example of the first embodiment;

FIG. 10 is an enlarged cross-sectional view illustrating a vicinity of an opening 46B according to the second example of the first embodiment;

FIG. 11 is an enlarged cross-sectional view illustrating a vicinity of an opening 46A according to the second example of the first embodiment;

FIG. 12 is a side view illustrating the multilayer ceramic capacitor according to the first embodiment; and

FIG. 13 is an enlarged cross-sectional view of a vicinity of a coating layer in a multilayer ceramic capacitor according to the first embodiment.

### DESCRIPTION OF THE PREFERRED EMBODIMENTS

In the following, embodiments of the present invention will be described with reference to the accompanying drawings. In the drawings, the same or corresponding constituent elements are denoted with the same reference numerals, and redundant description thereabout may be omitted.

### FIRST EMBODIMENT

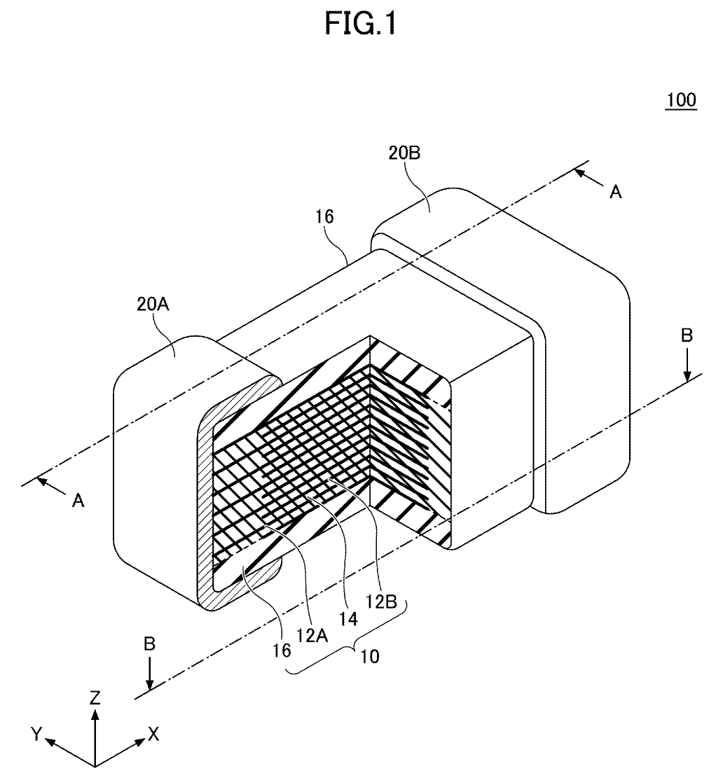

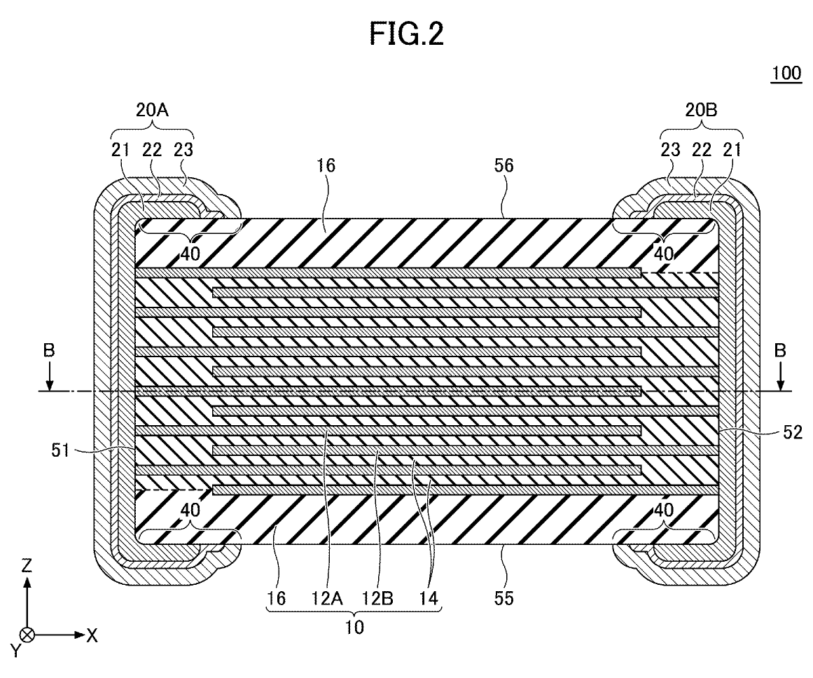

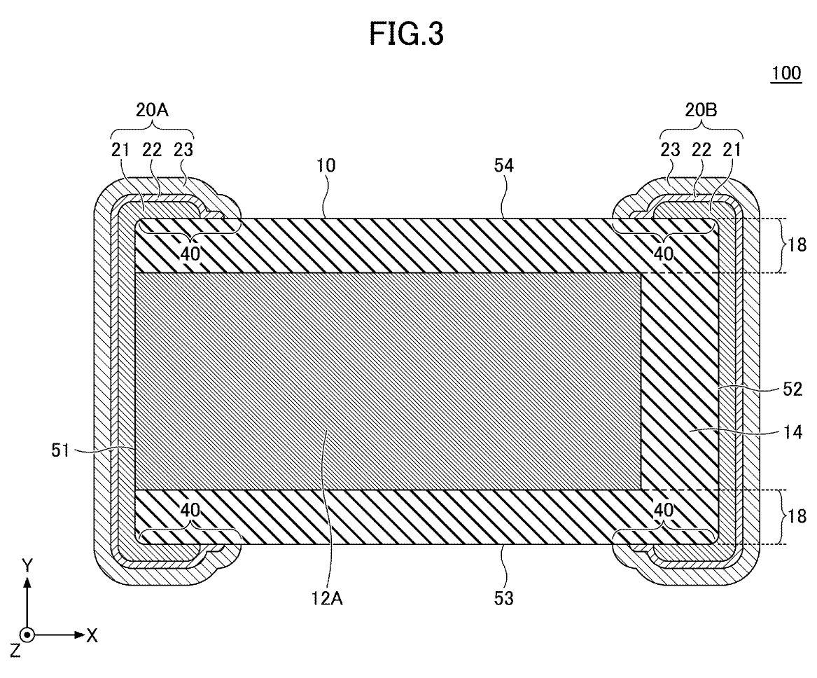

A multilayer ceramic capacitor will be described as an example of a multilayer ceramic electronic component. FIG. 1 is a partial cross-sectional perspective view illustrating a multilayer ceramic capacitor 100 according to a first embodiment. FIG. 2 is a cross-sectional view taken along a line A-A of FIG. 1. FIG. 3 is a cross-sectional view taken along a line B-B of FIG. 1.

In FIGS. 1 to 3, a Z-direction (first direction) is a lamination direction in which a dielectric layer 14 and internal electrodes 12A and 12B are laminated, and a direction in which a lower surface 55 and an upper surface 56 of an element body 10 are opposite each other. An X-direction (second direction) is a length direction of the element body 10, and a direction in which a pair of end surfaces 51 and 52 of the element body 10 are opposite each other. A Y-direction (third direction) is a width direction of the internal electrodes 12A and 12B, and a direction in which a pair of lateral surfaces 53 and 54 of the element body 10 are opposite each other. The X-direction, the Y-direction, and the Z-direction intersect or are perpendicular to each other.

A multilayer ceramic capacitor 100 includes an element body 10 having a substantially rectangular parallelepiped shape, and external electrodes 20A and 20B. The element body 10 has a plurality of dielectric layers 14, a plurality of internal electrodes 12A and 12B, and cover dielectric layers 16. The plurality of internal electrodes 12A and the plurality of internal electrodes 12B are alternately laminated. One of the plurality of dielectric layers 14 is provided between one of the plurality of internal electrodes 12A and one of the plurality of internal electrodes 12B. The outermost layers in the Z-direction of the laminate in which the dielectric layer 14 and the internal electrodes 12A and 12B are laminated are respectively one of the internal electrodes 12A and 12B, and the lower surface and the upper surface of the laminate are covered with a corresponding cover dielectric layer 16 of the cover dielectric layer 16. A region sandwiching the plurality of internal electrodes 12A and 12B in the Y-direction is a side margin region 18.

The internal electrodes 12A and 12B are alternately exposed to the end surfaces 51 and 52. The internal electrodes 12A are exposed at the end surface 51, and the internal electrodes 12B are not exposed at the end surface 51. The internal electrodes 12B are exposed at the end surface 52, and the internal electrodes 12A are not exposed at the end surface 52. That is, the internal electrodes 12A and 12B are connected to different end surfaces 51 and 52.

The external electrode 20A is in contact with the internal electrodes 12A exposed at the end surface 51 of the element body 10. The external electrode 20B is in contact with the internal electrodes 12B exposed at the end surface 52 of the element body 10. In addition to the end surface 51, the external electrode 20A covers the end portions 40 of the lateral surfaces 53 and 54, the lower surface 55, and the upper surface 56 in a -X-direction. The end portions 40 are regions on the end surfaces 51 and 52 side of the surfaces of the element body 10 that adjoin the end surfaces 51 and 52. The external electrode 20B is in contact with the internal electrode 12B at the end surface 52. In addition to the end surface 52, the external electrode 20B covers the end portions 40 of the lateral surfaces 53 and 54, the lower surface 55, and the upper surface 56 in a +X-direction.

Each of the external electrodes 20A and 20B includes a base metal layer 21, a coating layer 22 and a plating layer 23. The coating layer 22 covers the base metal layer 21. The plating layer 23 covers the coating layer 22. On the lateral surfaces 53 and 54, the lower surface 55 and the upper surface 56, the coating layer 22 contacts the element body 10 outside the end of the base metal layer 21. The plating layer 23 contacts the element body 10 outside the end of the coating layer 22.

The size of the multilayer ceramic capacitor 100 may be, for example, but not limited to, a length (length in the X-direction) of 0.25 mm, a width (width in the Y-direction) of 0.125 mm, and a height (height in the Z-direction) of 0.125 mm; or a length of 0.4 mm, a width of 0.2 mm, and a height of 0.2 mm; or a length of 0.6 mm, a width of 0.3 mm, and a height of 0.3 mm; or a length of 1.0 mm, a width of 0.5 mm, and a height of 0.5 mm; or a length of 3.2 mm, a width of 1.6 mm, and a height of 1.6 mm; or a length of 4.5 mm, a width of 3.2 mm, and a height of 2.5 mm.

The internal electrodes 12A and 12B are mainly composed of a base metal such as nickel (Ni), copper (Cu), and tin (Sn). For the internal electrodes 12A and 12B, a noble metal such as platinum (Pt), palladium (Pd), silver (Ag), or gold (Au), or an alloy containing these may be used. The internal electrodes 12A and 12B have a thickness of, for example, 0.1 μm or more and 1 μm or less.

The dielectric layer 14 has, for example, a ceramic material having a perovskite structure represented by a general formula ABO₃ as a main phase. The perovskite structure includes ABO_{3 - α} differing from above stoichiometric composition. For example, the ceramic material may be selected from at least one of barium titanate (BaTiO₃), calcium zirconate (CaZrO₃), calcium titanate (CaTiO₃), strontium titanate (SrTiO₃), magnesium titanate (MgTiO₃), and Ba_{1 – x}_{–}_{y}CaₓSr_{y}Ti_{1 -} _{z}Zr_{z}O₃ (0 ≤ x ≤ 1, 0 ≤ y ≤ 1, 0 ≤ z ≤ 1) forming a perovskite structure. Ba_{1 – x}_{–}_{y}CaₓSr_{y}Ti_{1 - z}Zr_{z}O₃ is barium strontium titanate, barium calcium titanate, barium zirconate, barium zirconate titanate, calcium zirconate titanate, barium calcium zirconate titanate, and the like. For example, the dielectric layer 14 contains 90 atom% or more of the main component ceramic. The thickness of the dielectric layer 14 is, for example, 0.3 μm or more and 2 μm or less.

Additives may be added to the dielectric layer 14. Additives to the dielectric layer 14 include such as oxides of zirconium (Zr), hafnium (Hf), magnesium (Mg), manganese (Mn), molybdenum (Mo), vanadium (V), chromium (Cr), rare earth elements yttrium (Y), samarium (Sm), europium (Eu), gadolinium (Gd), terbium (Tb), dysprosium (Dy), holmium (Ho), erbium (Er), thulium (Tm) and ytterbium (Yb), or oxides containing cobalt (Co), nickel (Ni), lithium (Li), boron (B), sodium (Na), potassium (K), or silicon (Si), or glasses containing cobalt, nickel, lithium, boron, sodium, potassium, or silicon.

The composition of the main ceramic component of the cover dielectric layer 16 may be the same as or different from that of the main ceramic component of the dielectric layer 14.

The base metal layer 21 is mainly composed of, for example, a metal such as copper, nickel, aluminum (Al), zinc (Zn), or an alloy of two or more of these (e.g. an alloy of copper and nickel), and includes a ceramic component such as a glass component for densifying the base metal layer 21, a co-firing material for controlling sinterability of the external electrodes 20A and 20B, and the like. The glass component is an oxide such as barium (Ba), strontium (Sr), calcium (Ca), zinc, aluminum, silicon, or boron. The thickness of the base metal layer 21 is, for example, 3 μm to 50 μm.

The coating layer 22 is a laminated film having, for example, a metal such as copper, titanium, molybdenum, tantalum, chromium, aluminum, alumina, or tin, or metal layers of two or more of these. The coating layer 22 does not contain, for example, nickel as a main component. The coating layer 22 is a layer formed by, for example, a sputtering method. The thickness of the coating layer 22 is, for example, 3 nm to 2 μm.

The plating layer 23 is mainly composed of, for example, a metal such as copper, nickel, aluminum, zinc, or tin, or an alloy of two or more of these metals. The plating layer 23 may be a plating layer of a single metal component or a plurality of plating layers of different metal components. Furthermore, a film of a conductive resin such as an epoxy resin or a urethane resin may be formed on a surface of the plating layer 23. The thickness of the plating layer 23 is, for example, 5 μm to 15 μm.

### MANUFACTURING METHOD OF FIRST EMBODIMENT

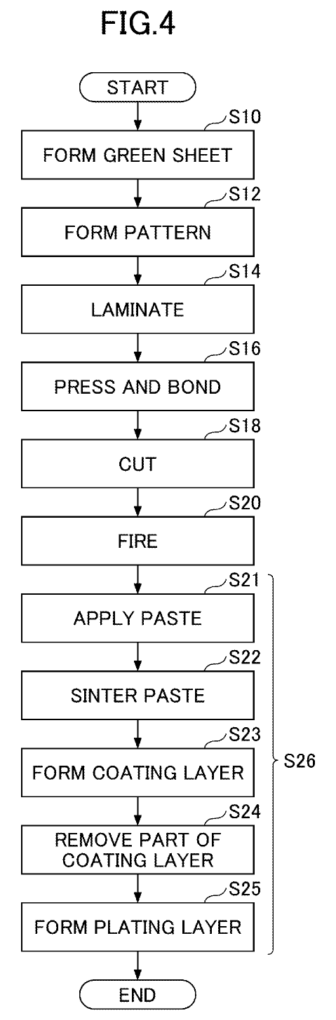

A manufacturing method of the multilayer ceramic capacitor 100 will be described. FIG. 4 is a flowchart illustrating a method for manufacturing a multilayer ceramic capacitor according to the first embodiment.

### GREEN SHEET FORMING STEP

First, a green sheet is formed (step S10). In the step S10, a dielectric material is prepared by adding various additives (such as sintering aids) to ceramic powder, for example. A binder such as polyvinyl butyral (PVB) resin, an organic solvent such as ethanol or toluene, and a plasticizer are added to the prepared dielectric material, and a slurry is formed by wet mixing. Using the prepared slurry, the green sheet is formed on a base material by, for example, a die-coating method or a doctor-blade method. The base material is, for example, a PET (polyethylene terephthalate) film. Then, the green sheet is dried.

### PATTERN FORMING STEP

Subsequently, metal patterns to be internal electrodes 12A and 12B are formed on the green sheet (step S12). In the step S12, conductor paste for forming the internal electrodes containing an organic binder is printed on the green sheet on the base material by, for example, gravure printing. Thus, a plurality of metal patterns corresponding to the internal electrodes 12A and 12B are formed on the green sheet while being separated from each other. The conductor paste contains metal powder as a main component such as nickel powder, a binder, and an organic solvent. Ceramic particles may be added to the conductor paste as a co-firing material.

### LAMINATING STEP

Subsequently, the green sheets are laminated (step S14). In the step S14, a laminated sheet is formed by laminating green sheets on which metal patterns serving as internal electrodes 12A and 12B are printed. Green sheets corresponding to the cover dielectric layer 16 are laminated on both end surfaces of the laminated sheet in the lamination direction.

### PRESSING AND BONDING STEP

Subsequently, the laminated sheets are pressed and bonded (step S16). In the step S16, a plurality of green sheets are laminated together by pressing and bonding the laminated sheet formed in the step S14, and a hydrostatic press may be used as a pressing and bonding method.

### CUTTING STEP

Subsequently, the laminated sheet is cut (step S18). In the step S18, a plurality of element bodies 10 are prepared by cutting the laminated sheet in the lamination direction along a predetermined cut line by a cutting blade. In the element body 10, the internal electrode 12A is exposed at the end surface 51, and the internal electrode 12B is exposed at the end surface 52. After the step S18, the element body 10 may be polished using a method such as barrel polishing. As a result, corners of the element body 10 are rounded.

### FIRING STEP

Subsequently, the element body 10 is fired (step S20). In the step S20, the element body 10 is subjected to binder removal in a nitrogen gas atmosphere at 250°C to 500°C and then fired in a reducing atmosphere at 1300°C to 1400°C for approximately one hour. Thus, the element body 10 and particles of the internal electrodes 12A and 12B are sintered.

### EXTERNAL ELECTRODE FORMING STEP

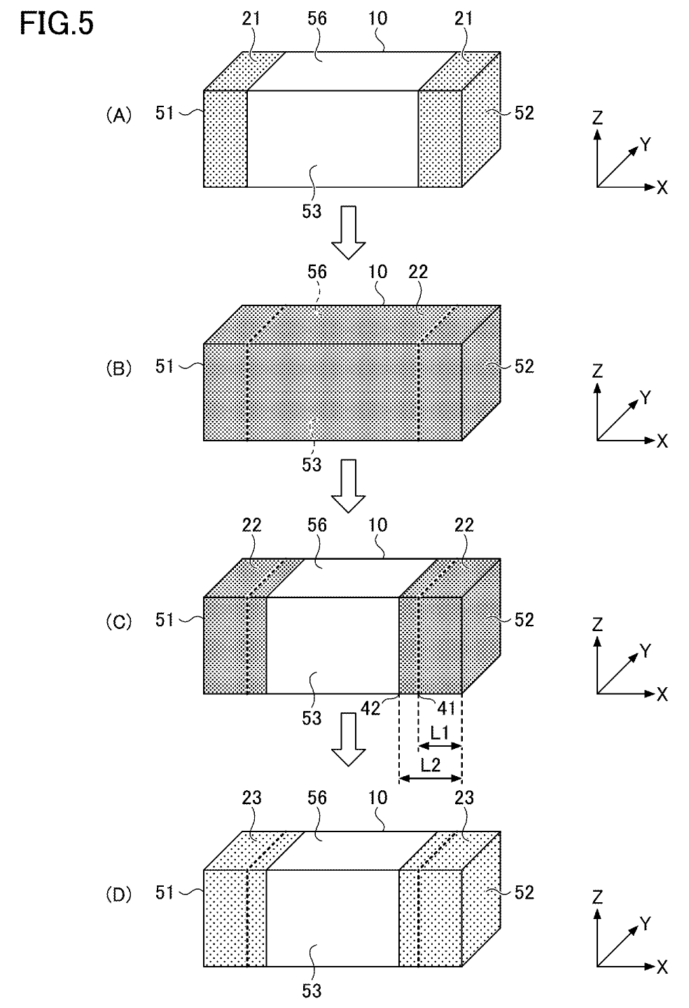

Subsequently, the external electrodes 20A and 20B are formed (step S26). The step S26 includes steps S21 to S25. Portions (A) to (D) of FIG. 5 are perspective views illustrating a method of manufacturing the multilayer ceramic capacitor according to the first embodiment.

First, paste is applied to the element body 10 (step S21). For example, the paste is applied to the end portions 40 and the end surface 51 of the element body 10 by, for example, a dip method. The paste contains metal particles as main components, glass particles (glass frit), a binder, and an organic solvent.

Next, the paste is sintered (step S22). In the step S22, the paste as a raw material for the base metal layer 21 is fired in a nitrogen atmosphere at 750°C to 850°C, which is lower than the firing temperature in the step S20. Thus, as shown in the portion (A) of FIG. 5, the paste is sintered to form the base metal layer 21 on the element body 10. Incidentally, the element body 10 and the paste may be sintered in the step S22 without firing in the step S20. In this case, the firing conditions are the same as those in the step S20.

Next, the coating layer 22 is formed on the element body 10 and the base metal layer 21 (step S23). As shown in the portion (B) of FIG. 5, the coating layer 22 is formed on the entire six faces of the element body 10. A sputtering method is used to form the coating layer 22. As the sputtering method, for example, a powder sputtering method is used. The powder sputtering method is a method for forming a sputtering film on the surface of powder. By using powder sputtering, uniform sputtering over the entire surface can be achieved even when an object to be sputtered is small in size and area. Thus, the coating layer 22 is formed on entirety of the six faces of the element body 10. Further, for example, by masking selected portions of the hexahedral body before sputtering, the coating layer 22 can be deposited on the unmasked areas.

Next, the coating layer 22 is removed from the central portion of the element body 10 in the X-direction (step S24). As shown in the portion (C) of FIG. 5, the coating layer 22 of the central portion of the element body 10 in the X-direction is removed. A distance L2 between an end 42 of the coating layer 22 and the end surface 52 in the X-direction is made larger than a distance L1 between an end 41 of the base metal layer 21 and the end surface 52 in the X-direction. Thus, the tip of the coating layer 22 comes into contact with the element body 10. As a method for removing a part of the coating layer 22, for example, a laser beam is used. When selected portions of the hexahedral body have been masked and the coating layer 22 has been deposited on the unmasked areas, the step S24 does not need to be performed.

Next, the plating layer 23 is formed (step S25). As shown in the portion (D) of FIG. 5, the plating layer 23 is formed to cover the coating layer 22. The base metal layer 21, the coating layer 22, and the plating layer 23 form external electrodes 20A and 20B.

### MULTILAYER CERAMIC CAPACITOR OF FIRST COMPARATIVE EMBODIMENT

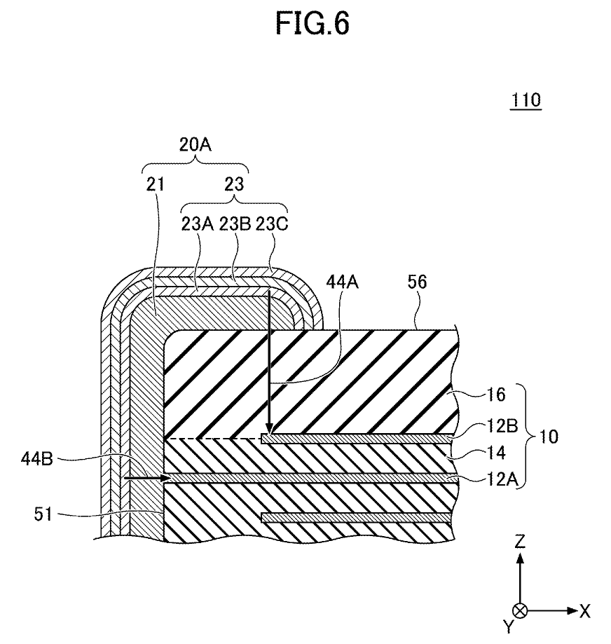

FIG. 6 is a cross-sectional view illustrating a multilayer ceramic capacitor according to a first comparative embodiment. As shown in FIG. 6, the multilayer ceramic capacitor 110 of the first comparative embodiment is not provided with the coating layer 22. The base metal layer 21 is composed mainly of nickel. The plating layer 23 has a first layer 23A, a second layer 23B, and a third layer 23C. The first layer 23A coats the base metal layer 21. The second layer 23B coats the first layer 23A. The third layer 23C coats the second layer 23B. The first layer 23A is composed mainly of copper. The second layer 23B is composed mainly of nickel. The third layer 23C is composed mainly of tin.

The third layer 23C is a layer to be soldered when the multilayer ceramic capacitor 110 is solder-mounted. The second layer 23B is a barrier layer between the first layer 23A and the third layer 23C. When the base metal layer 21 is composed mainly of nickel, it is difficult to directly plate the second layer 23B composed mainly of nickel onto the base metal layer 21, and therefore the first layer 23A is provided. The second layer 23B composed mainly of nickel is easy to plate on the first layer 23A composed mainly of copper.

The plating layer 23 contains a large amount of hydrogen. When the base metal layer 21 is mainly composed of nickel, the base metal layer 21 diffuses hydrogen easily and stores hydrogen easily. Therefore, it is considered that hydrogen (or hydrogen ions H+) diffuses from the plating layer 23 through the base metal layer 21 and the element body 10 to reach the internal electrode 12A or 12B as indicated by an arrow 44A. Further, hydrogen reaches the internal electrode 12A from the plating layer 23 through the base metal layer 21 as indicated by the arrow 44B. Further, it is considered that hydrogen diffuses to the adjacent dielectric layer 14. As a result, insulation resistance of the dielectric layer 14 decreases.

### MULTILAYER CERAMIC CAPACITOR OF SECOND COMPARATIVE EMBODIMENT

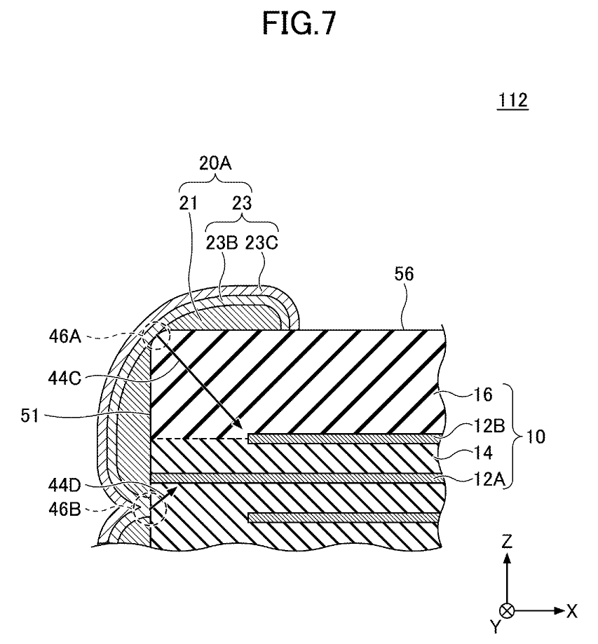

FIG. 7 is a cross-sectional view illustrating a multilayer ceramic capacitor according to a second comparative embodiment. As shown in FIG. 7, the multilayer ceramic capacitor 112 of the second comparative example is not provided with the coating layer 22. The base metal layer 21 is mainly composed of copper. The plating layer 23 has the second layer 23B and the third layer 23C. The second layer 23B covers the base metal layer 21. The third layer 23C covers the second layer 23B. The second layer 23B is mainly composed of nickel. The third layer 23C is mainly composed of tin.

In the multilayer ceramic capacitor 112 of the second comparative example, the base metal layer 21 is mainly composed of copper. Therefore, it is easy to plate the second layer 23B mainly composed of nickel on the base metal layer 21. Therefore, it is not necessary to provide the first layer 23A.

In the second comparative example, since the base metal layer 21 is mainly composed of copper, it is difficult for hydrogen to diffuse through the base metal layer 21 as compared with the first comparative embodiment. However, when the base metal layer 21 becomes thinner with miniaturization of the multilayer ceramic capacitor, openings 46A and 46B are easily formed in the base metal layer 21. In some cases, the plating layer 23 comes into contact with the element body 10 at the bottom surfaces of the openings 46A and 46B. The openings 46A are formed at the corners where the end surfaces 51 and 52, the lateral surfaces 53 and 54, and the lower surface 55 and upper surface 56 of the element body 10 meet. Since the base metal layer 21 is thin at the corners of the element body 10, the openings 46A are easily formed at the corners. The opening 46B is an opening formed at the end surface 51 of the element body 10.

In the opening 46A, hydrogen diffuses from the plating layer 23 through the element body 10 to reach the internal electrode 12A or 12B as indicated by an arrow 44C. In addition, hydrogen flows from the plating layer 23 to the internal electrode 12A as indicated by an arrow 44D. Hydrogen diffuses through the internal electrodes 12A and 12B and diffuses into the dielectric layer 14 disposed between the internal electrodes 12A and 12B that are opposite each other. As a result, as in the first comparative embodiment, insulation resistance of the dielectric layer decreases.

### FIRST EXAMPLE OF FIRST EMBODIMENT

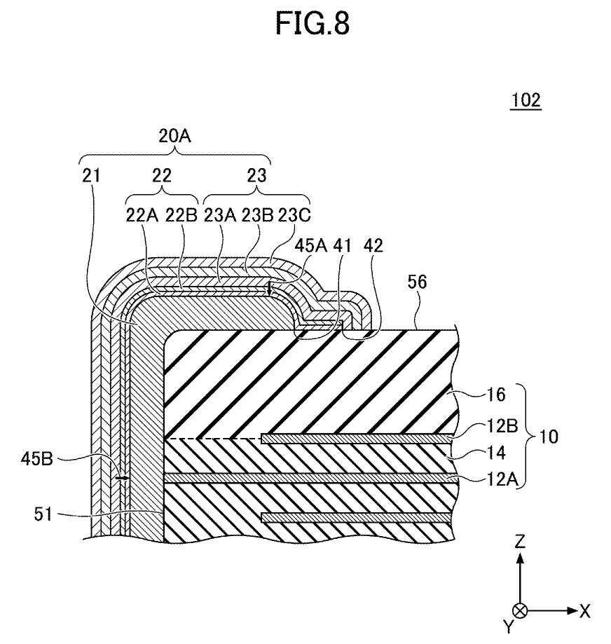

FIG. 8 is a cross-sectional view illustrating a multilayer ceramic capacitor according to a first example of the first embodiment. As shown in FIG. 8, in the multilayer ceramic capacitor 102 of the first example of the first embodiment, the coating layer 22 is provided between the base metal layer 21 and the plating layer 23. The end 42 of the coating layer 22 is located on the +X side with respect to the end 41 of the base metal layer 21. The coating layer 22 includes, for example, a fourth layer 22A and a fifth layer 22B in order from the base metal layer 21 side. The fourth layer 22A is an adhesion layer between the base metal layer 21 and the fifth layer 22B, and may be mainly composed of titanium, tantalum, or chromium. As one example, it may be mainly composed of titanium. The fifth layer 22B is a layer that facilitates plating of the plating layer 23 on the coating layer 22, and is mainly composed of, for example, copper. The structure is otherwise the same as that of the first comparative embodiment, and the base metal layer 21 is mainly composed of nickel.

The coating layer 22 formed by the sputtering method contains only a small amount of hydrogen. The coating layer 22 has a smaller diffusion coefficient of hydrogen than that of nickel, and storing of hydrogen is impeded as compared to nickel. Therefore, hydrogen in the plating layer 23 does not readily diffuse into the base metal layer 21. Therefore, as shown by arrows 45A and 45B, the coating layer 22 acts as a barrier, and hydrogen does not readily diffuse into the internal electrodes 12A and 12B through the base metal layer 21 and the element body 10, so that a decrease in the insulation resistance of the dielectric layer 14 can be reduced.

### SECOND EXAMPLE OF FIRST EMBODIMENT

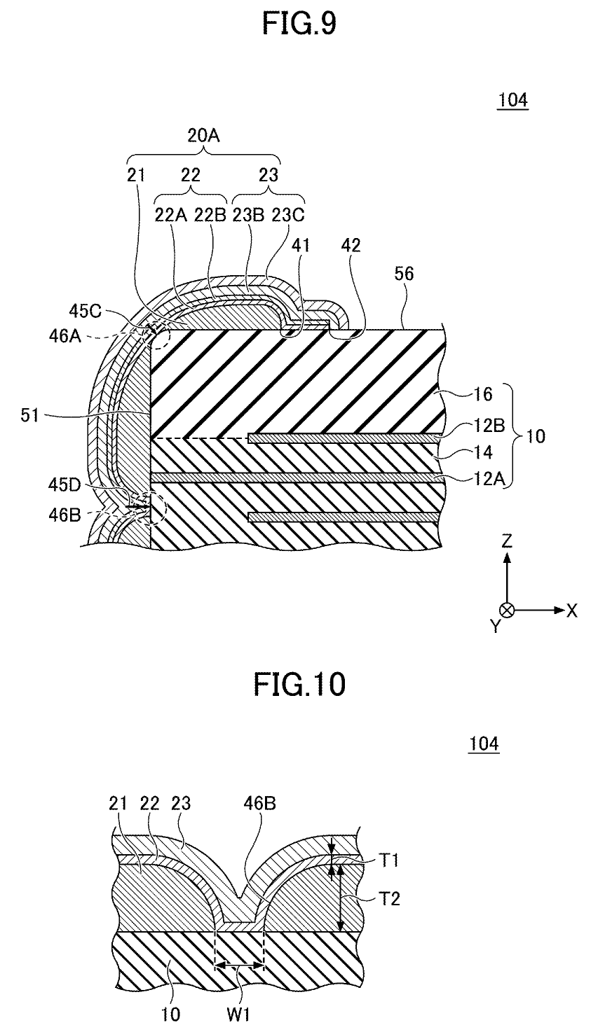

FIG. 9 is a cross-sectional view illustrating a multilayer ceramic capacitor according to a second example of the first embodiment. As shown in FIG. 9, in the multilayer ceramic capacitor 104 of the second example of the first embodiment, the coating layer 22 is provided between the base metal layer 21 and the plating layer 23. The structure of the coating layer 22 is the same as that in the first example of the first embodiment. Other structures are the same as those in the second comparative example, and the base metal layer 21 is mainly composed of copper.

The coating layer 22 covers the inner surfaces of the openings 46A and 46B. Therefore, as indicated by arrows 45C and 45D, the coating layer 22 acts as a barrier, and hydrogen does not appreciably diffuse into the internal electrodes 12A and 12B through the element body 10 in the openings 46A and 46B. Therefore, hydrogen does not appreciably diffuse into the dielectric layer 14 from the internal electrodes 12A and 12B, and a decrease in the insulation resistance of the dielectric layer 14 can be reduced.

FIG. 10 is an enlarged cross-sectional view illustrating a vicinity of an opening 46B according to a second example of the first embodiment. As shown in FIG. 10, the coating layer 22 covers the entire inner surface of the opening 46B. The maximum width of the element body 10 exposed through the opening 46B is W1. The maximum width W1 is the largest width among widths of a region where the element body 10 is exposed at the base metal layer 21. The thickness of the coating layer 22 outside the opening 46A is T1. The thickness of the base metal layer 21 outside the opening 46A is T2.

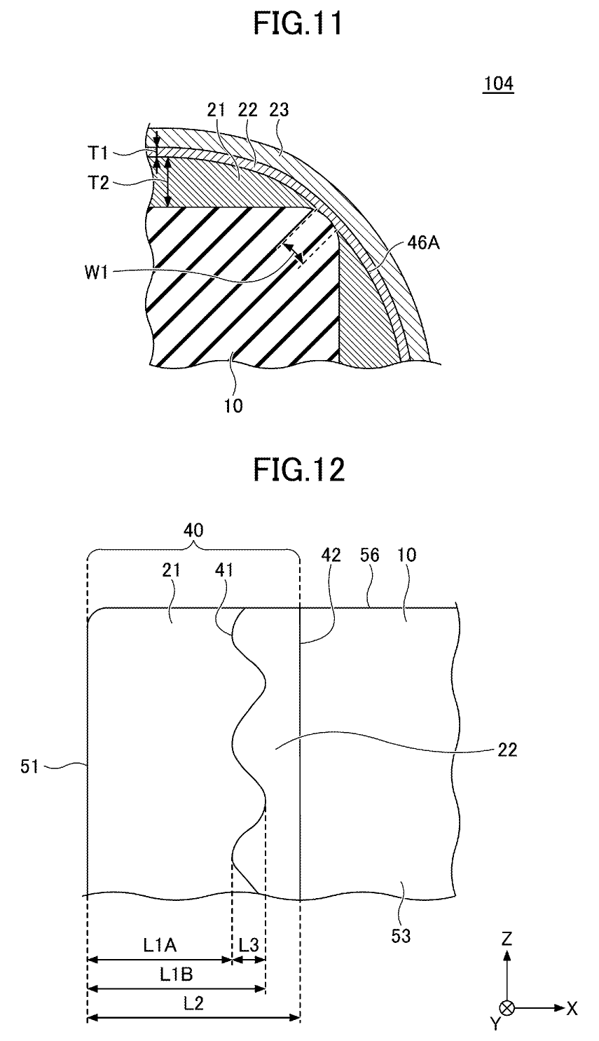

FIG. 11 is an enlarged cross-sectional view illustrating a vicinity of an opening 46A according to the second example of the first embodiment. As shown in FIG. 11, the coating layer 22 covers the entire inner surface of the opening 46A. The maximum width along the surface of the element body 10 exposed through the opening 46A is W1. The thickness of the coating layer 22 outside the opening 46A is T1. The thickness of the base metal layer 21 outside the opening 46A is T2.

When the coating layer 22 is formed by using the sputtering method, the coating layer 22 can be formed to cover all the inner surfaces of the openings 46A and 46B. Moreover, the coating layer 22 can be made thin. For example, when the plating layer is formed to cover the inner surfaces of the openings 46A and 46B by using the plating method, the thickness of the plating layer is equal to or more than half of the maximum width W1. When the coating layer 22 is formed by using the sputtering method, the thickness T1 of the coating layer 22 can be less than half of the maximum width W1.

According to the first embodiment, as in the steps S23 and S24 in FIG. 4, the coating layer 22 for coating the base metal layer 21 is formed by using the sputtering method. As in the step S25, the plating layer 23 for coating the coating layer 22 is formed. In this way, the sputtering layer is used as the coating layer 22. The hydrogen concentration of the sputtering layer is lower than that of the plating layer 23. Therefore, diffusion of hydrogen from the plating layer 23 to the element body 10 can be reduced, and lowering of the insulation resistance of the dielectric layer 14 can be reduced. When the coating layer 22 is a metal layer, the base metal layer 21 and the plating layer 23 can be brought into electrical contact. The coating layer 22 is preferably provided so that the base metal layer 21 is not exposed at the surface of the coating layer 22. When the coating layer 22 is provided on a part of the surface of the base metal layer 21 and a portion where the base metal layer 21 and the plating layer 23 are in contact is provided, the coating layer 22 may be an insulating layer.

As shown in FIG. 7, when the base metal layer 21 has openings 46A and 46B through which the element body 10 is exposed, hydrogen in the plating layer 23 tends to diffuse into the element body 10. Therefore, the coating layer 22 is provided to cover the inner surfaces of the openings 46A and 46B. This prevents hydrogen in the plating layer 23 from diffusing into the element body 10 through the openings 46A and 46B. Therefore, deterioration of the multilayer ceramic capacitor characteristics can be reduced.

As shown in FIGS. 10 and 11, the thickness T1 of the coating layer 22 can be less than half of the maximum width W1 of the bottom surfaces of the openings 46A and 46B. In this way, the coating layer 22 can be made thin. The thickness T1 may be 1/5 or less of the maximum width W1, and may be 1/10 or less. The thickness T1 is, for example, 1/10 or less of the thickness T2 of the base metal layer 21, or is 1/20 or less. From the viewpoint that the coating layer 22 functions as a hydrogen diffusion preventing layer, the thickness T1 is preferably 3 nm or more, and more preferably 10 nm or more.

When the maximum width W1 is too large, the resistance of the external electrodes 20A and 20B increases. From this viewpoint, the maximum width W1 is preferably five times or less of the thickness T2 of the base metal layer 21, and more preferably two times or less. When the maximum width W1 is small, the diffusion of hydrogen from the plating layer 23 to the element body 10 is not greatly affected. From this viewpoint, the maximum width W1 is, for example, 1/100 or more of the thickness T2 of the base metal layer 21.

As shown in the portion (B) of FIG. 5, the coating layer 22 is formed on the base material layer 21 and on the lateral surfaces 53 and 54, the lower surface 55, and the upper surface 56 of the element body 10 that are exposed from the base metal layer 21 (i.e., the surfaces adjoining the end surfaces 51 and 52) by a sputtering method. As shown in the portion (C) of FIG. 5, the coating layer 22 is removed from the central portions of the lateral surfaces 53 and 54, the lower surface 55, and the upper surface 56 in the X-direction. Thus, the coating layer 22 can be formed on the end portions 40 of the element body 10.

When the coating layer 22 is a layer mainly composed of nickel, hydrogen easily diffuses through the coating layer 22. Therefore, the coating layer 22 is mainly composed of a metal element other than nickel. Examples of the metal element reducing diffusion of hydrogen include copper, titanium, molybdenum, tantalum, chromium, aluminum, or tin.

The coating layer 22 may have the fourth layer 22A and the fifth layer 22B as shown in FIGS. 8 and 9. When the fourth layer 22A is mainly composed of titanium, molybdenum, or chromium, adhesion between the base metal layer 21 and the fifth layer 22B can be improved. Since the fifth layer 22B is composed mainly of copper, the plating layer 23 can be easily plated.

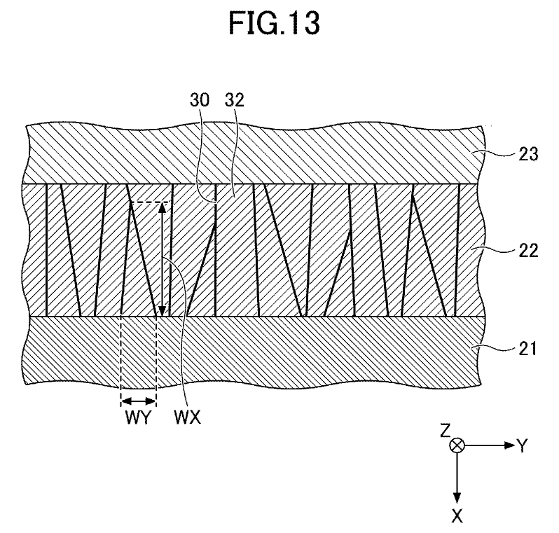

FIG. 12 is a side view of a multilayer ceramic capacitor according to the first embodiment. FIG. 12 illustrates an end 41 of the base metal layer 21 and an end 42 of the coating layer 22 on the surface (lateral surface 53) of the element body 10. As shown in FIG. 12, when the base metal layer 21 is formed by applying paste and sintering as in the steps S21 and S22 of FIG. 4, it is difficult to form the end 41 with high accuracy. Therefore, the end 42 on the lateral surface 53 has irregularities in the X-direction. The shortest distance between the end surface 51 and the end 41 is L1A, and the longest distance is L1B. The difference between the distances L1A and L1B is L3.

As shown in FIGS. 2, 3, and the portion (A) of FIG. 5, the base metal layer 21 includes a portion formed on the end surface 51 and an extension that wraps around onto the surfaces of the element body 10 adjacent to the end surface 51 (i.e., the portion of the base metal layer 21 at the end portion 40). As shown in the portion (B) of FIG. 5, the coating layer 22 is formed on the lateral surfaces 53 and 54, the lower surface 55, and the upper surface 56 (surfaces adjacent to the end surfaces 51 and 52) of the element body 10 exposed at the base metal layer 21 and the base metal layer 21 by using a sputtering method. As shown in the portion (C) of FIG. 5, the coating layer 22 is removed from the central portions of the lateral surfaces 53 and 54, the lower surface 55, and the upper surface 56 in the X-direction. Thus, the coating layer 22 can be formed on the end portions 40 of the element body 10. The end 42 (end portion) of the coating layer 22 is located on the side opposite to the end surface 51 relative to the end 41 of the base metal layer 21. Therefore, the coating layer 22 is in contact with the element body 10. That is, the end portion of the coating layer 22 extends farther in the X-direction than the extension at the end portion 40 of the base metal layer 21. The surface on which the end portion of the coating layer 22 extends in the X-direction from the extension of the base metal layer 21 is at least one of the lateral surfaces 53 and 54, the lower surface 55, and the upper surface 56 of the element body 10.

As described above, by making the distance L2 larger than the distance L1B, the areas of the external electrodes 20A and 20B at the end portions 40 can be increased. Therefore, when the multilayer ceramic capacitor is mounted, the areas bonded to a circuit board by solder can be increased. Therefore, the multilayer ceramic capacitor can be prevented from peeling off from the circuit board. The distance L2 is preferably 1.1 times or more of the distance L1B, and more preferably 1.2 times or more. For example, the distance L2 – L1B is 10 μm to 100 μm.

Further, by removing a part of the coating layer 22 as shown in the step S24 and the portion (C) of FIG. 5, the end 42 can be formed with high accuracy. Therefore, the distance L2 between the end surface 51 and the end 42 can be made substantially constant with high accuracy. For example, in the step of removing a part of the coating layer 22, by irradiating the laser beam to remove the coating layer 22, the end 42 can be formed with high accuracy.

On the lateral surfaces 53 and 54, the lower surface 55, and the upper surface 56, the end 42 (end portion) of the coating layer 22 has smaller surface irregularities than the end 41 (end portion) of the base metal layer. Thus, the areas of the external electrodes 20A and 20B at the end portions 40 can be formed with high accuracy. For example, the distance L3 is 10 μm to 250 μm.

FIG. 13 is an enlarged cross-sectional view of a vicinity of a coating layer in a multilayer ceramic capacitor according to the first embodiment. FIG. 13 is an enlarged cross-sectional view of the external electrode 20A provided on the end surface 51, wherein the thickness direction of the coating layer 22 is the X-direction, and the surface directions of the coating layer 22 are the Y-direction and the Z-direction. As shown in FIG. 13, the coating layer 22 formed by the sputtering method often exhibits a columnar structure. That is, the coating layer 22 often includes columnar crystalline grains 32. An interface between adjacent crystalline grains 32 forms a grain boundary 30.

At least one of the crystalline grains 32 in the columnar structure has a width WX in the X-direction that is at least 1.2 times, at least two times, or at least five times its width WY in the Y-direction. The crystalline grains 32 can be observed using, for example, a TEM (Transmission Electron Microscope).

In the first embodiment, when a certain layer contains a certain element as a main component, it is sufficient that a certain element is contained in a certain member to an extent that the effect of the embodiment is obtained, and the concentration of the certain element in a certain member is, for example, 50 mol% or more, 80 mol% or more, or 90 mol% or more.

Further, the present invention is not limited to these embodiments, and various variations and modifications may be made without departing from the scope of the present invention.

The embodiments disclosed above include, for example, the following aspects.

<1> A multilayer ceramic electronic component including:

an element body in which a plurality of internal electrodes and a plurality of dielectric layers having a ceramic as a main component are alternately laminated, the element body having end surfaces opposite each other in a longitudinal direction in which each of the plurality of internal electrodes extends;

a base metal layer provided on each of the end surfaces to be in contact with at least part of the plurality of internal electrodes exposed at either one of the end

surfaces;

a coating layer covering the base metal layer; and

a plating layer covering the coating layer and forming an external electrode together with the base metal layer and the coating layer.

<2> The multilayer ceramic electronic component according to <1>, wherein:

the base metal layer includes a portion formed on each of the end surfaces and an extension that wraps around onto surfaces of the element body adjacent to the each of the end surfaces; and

an end portion of the coating layer extends farther in the longitudinal direction than the extension of the base metal layer.

<3> The multilayer ceramic electronic component according to <2>, wherein the end portion of the coating layer has smaller surface irregularities than an end portion of the base metal layer on the surfaces on the element body adjacent to the each of the end surfaces.

<4> The multilayer ceramic electronic component according to any one of <1> to <3>, wherein the coating layer includes columnar crystalline grains.

<5> The multilayer ceramic electronic component according to any one of <1> to <4>, wherein the coating layer has a metal element other than nickel as a main component.

<6> The multilayer ceramic electronic component according to any one of <1> to <5>, wherein:

the base metal layer is provided with an opening through which the element body is exposed; and

the coating layer covers an inner surface of the opening.

<7> The multilayer ceramic electronic component according to <6>, wherein a thickness of the coating layer is less than half of a maximum width of a bottom surface of the opening.

<8> The multilayer ceramic electronic component according to <6> or <7>, wherein the opening is formed at a corner where one of the end surfaces and portions of surfaces adjoining the one of the end surfaces meet.

<9> A multilayer ceramic electronic component including:

an element body in which a plurality of internal electrodes and a plurality of dielectric layers having a ceramic as a main component are alternately laminated, the element body having end surfaces opposite each other in a longitudinal direction in which each of the plurality of internal electrodes extends;

a base metal layer provided on each of the end surfaces to be in contact with at least part of the plurality of internal electrodes exposed at either one of the end surfaces, and provided with an opening;

a coating layer covering the base metal layer, and being a sputtering layer; and

a plating layer covering the coating layer and forming an external electrode together with the base metal layer and the coating layer.

<10> A method of manufacturing a multilayer ceramic electronic component including:

preparing an element body in which a plurality of internal electrodes and a plurality of dielectric layers having a ceramic as a main component are alternately laminated, the element body having end surfaces opposite each other in a longitudinal direction in which each of the plurality of internal electrodes extends;

forming a base metal layer provided on each of the end surfaces to be in contact with at least part of the plurality of internal electrodes exposed at either one of the end surfaces, and provided with an opening;

forming a coating layer covering the base metal layer using a sputtering method; and

forming a plating layer covering the coating layer and forming an external electrode together with the base metal layer and the coating layer using a plating method.

<11> The method of manufacturing the multilayer ceramic electronic component according to <10>, wherein the forming the coating layer includes:

forming the coating layer on the base metal layer and surfaces adjacent to the end surfaces of the element body exposed from the base metal layer; and

removing the coating layer from central portions of the surfaces adjacent to the end surfaces in the longitudinal direction in which the end surfaces are opposite each other.

What is claimed is:

1. A multilayer ceramic electronic component comprising:
an element body in which a plurality of internal electrodes and a plurality of dielectric layers having a ceramic as a main component are alternately laminated, the element body having end surfaces opposite each other in a longitudinal direction in which each of the plurality of internal electrodes extends;
a base metal layer provided on each of the end surfaces to be in contact with at least part of the plurality of internal electrodes exposed at either one of the end surfaces;
a coating layer covering the base metal layer; and
a plating layer covering the coating layer and forming an external electrode together with the base metal layer and the coating layer.

2. The multilayer ceramic electronic component according to claim 1, wherein:
the base metal layer includes a portion formed on each of the end surfaces and an extension that wraps around onto surfaces of the element body adjacent to the each of the end surfaces; and
an end portion of the coating layer extends farther in the longitudinal direction than the extension of the base metal layer.

3. The multilayer ceramic electronic component according to claim 2, wherein the end portion of the coating layer has smaller surface irregularities than an end portion of the base metal layer on the surfaces on the element body adjacent to the each of the end surfaces.

4. The multilayer ceramic electronic component according to claim 1, wherein the coating layer includes columnar crystalline grains.

5. The multilayer ceramic electronic component according to claim 1, wherein the coating layer has a metal element other than nickel as a main component.

6. The multilayer ceramic electronic component according to claim 1, wherein:
the base metal layer is provided with an opening through which the element body is exposed; and
the coating layer covers an inner surface of the opening.

7. The multilayer ceramic electronic component according to claim 6, wherein a thickness of the coating layer is less than half of a maximum width of a bottom surface of the opening.

8. The multilayer ceramic electronic component according to claim 6, wherein the opening is formed at a corner where one of the end surfaces and portions of surfaces adjoining the one of the end surfaces meet.

9. A multilayer ceramic electronic component comprising:
an element body in which a plurality of internal electrodes and a plurality of dielectric layers having a ceramic as a main component are alternately laminated, the element body having end surfaces opposite each other in a longitudinal direction in which each of the plurality of internal electrodes extends;
a base metal layer provided on each of the end surfaces to be in contact with at least part of the plurality of internal electrodes exposed at either one of the end surfaces, and provided with an opening;
a coating layer covering the base metal layer, and being a sputtering layer; and
a plating layer covering the coating layer and forming an external electrode together with the base metal layer and the coating layer.

10. A method of manufacturing a multilayer ceramic electronic component comprising:
preparing an element body in which a plurality of internal electrodes and a plurality of dielectric layers having a ceramic as a main component are alternately laminated, the element body having end surfaces opposite each other in a longitudinal direction in which each of the plurality of internal electrodes extends;
forming a base metal layer provided on each of the end surfaces to be in contact with at least part of the plurality of internal electrodes exposed at either one of the end surfaces, and provided with an opening;
forming a coating layer covering the base metal layer using a sputtering method; and
forming a plating layer covering the coating layer and forming an external electrode together with the base metal layer and the coating layer using a plating method.

11. The method of manufacturing the multilayer ceramic electronic component according to claim 10, wherein the forming the coating layer includes:
forming the coating layer on the base metal layer and surfaces adjacent to the end surfaces of the element body exposed from the base metal layer; and
removing the coating layer from central portions of the surfaces adjacent to the end surfaces in the longitudinal direction in which the end surfaces are opposite each other.
